(19) United States
(12) Patent Application Publication
(10) Pub. No.: US 2014/0184949 A1
(43) Pub. Date: Jul. 3, 2014

(54) TOUCH PANEL

(71) Applicant: SAMSUNG ELECTRO-MECHANICS CO., LTD., Suwon-si (KR)

(72) Inventors: Jung Ryoul Yim, Suwon-si (KR); Seul Gi Kim, Suwon-si (KR); Jang Ho Park, Suwon-si (KR); In Hyun Jang, Suwon-si (KR)

(73) Assignee: SAMSUNG ELECTRO-MECHANICS CO., LTD., Suwon-si (KR)

(21) Appl. No.: 14/140,413

(22) Filed: Dec. 24, 2013

(30) Foreign Application Priority Data
Dec. 27, 2012 (KR) 10-2012-0154867

(51) Int. Cl. G06F 1/16

(52) U.S. Cl. CPC G06F 1/1692
USPC 349/12

(57) ABSTRACT

Disclosed herein is a touch panel in which an electrode pattern is opened along a shape of an electrode and a light blocking portion is formed to extend from an end portion of the opened pattern and have a predetermined angle with respect to the end portion to prevent an introduction of light even though an introduction path of light and a direction in which opened portions are arranged are consistent, thus preventing the opened portion from being visible.

### CROSS REFERENCE TO RELATED APPLICATION

This application claims the benefit of Korean Patent Application No. 10-2012-0154867, filed on Dec. 27, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

Due to the development of computers using digital technologies, auxiliary equipment of computers has also been developed, and personal computers, portable transmission devices, and other personalized information processing devices perform text and graphic processing by using various input devices such as a key board or a mouse.

However, the rapid increase of an information-oriented society has extended the purpose of computers, such that a currently used key board and mouse serving as input devices are insufficient to effectively drive products. Thus, demand for a device allowing any one to easily input information, as well as being simple and reducing the possibility of erroneous manipulation, is increasing.

In addition, interest in techniques regarding an input device, beyond a level satisfying general functions, has been shifted to reliability, durability, innovativeness, designing, processing- related technique, and the like, and in order to achieve such objects, a touch panel allowing for input information such as text, graphics, and the like, has been developed as an input device.

A touch panel is a tool installed on a display screen of a flat panel display device such as an electronic notebook, a liquid crystal display (LCD) device, a plasma display panel (PDP), an electroluminescence (EL), or the like, and an image display device such as a cathode ray tube (CRT), or the like, to allow users to select desired information while viewing the image display device.

A transparent electrode is used in an electrode pattern, and as known a transparent electrode is required to have light transmittance and conductivity. In general, indium tin oxide (ITO) has been known to have such characteristics. An ITO electrode uses an indium-tin oxide. The indium-tin oxide has properties of being readily attached to a hard material such as glass, or the like, so when it is spread thinly, it is transparent and conducts electricity.

However, ITO is produced as a byproduct in an In₂O₃ or Zn mine, or the like, having an unstable demand and supply and being inflexible, which, thus, is not appropriate for a flexible material such as polymer matrix, or the like. In addition, ITO is required to be manufactured under a high temperature and high pressure environment, increasing the unit cost of production.

In order to solve the problem, recently, a technique of forming an electrode by disposing an electrode pattern in a mesh form on a transparent substrate has been proposed. As known, a mesh form refers to a form including a plurality of crossings like a network.

Namely, an electrode pattern in a mesh form is formed to have a shape of an electrode, e.g., a quadrangular shape, and to this end, conventionally, a technique of forming an electrode pattern in a mesh form and subsequently forming an open portion along the electrode shape, e.g., a quadrangular shape, has been used.

However, in the related art as mentioned above, since the opened end portion of the electrode pattern corresponds to a direction in which open portions are arranged, if a direction in which open portions are arranged and a path of introduced light are consistent, light may be introduced between the open portions, allowing the opened portion to be visible.

Namely, when the user views the touch panel including a transparent electrode formed according to the related art by tilting it in various directions, the introduction path of light and the direction in which open portions are arranged may be consistent, and in this case, the opened portion is visible.

Meanwhile, the transparent substrate and the electrode pattern in a mesh form as described above are disclosed in patent documents below and a repeated description thereof will be omitted.

### PRIOR ART DOCUMENT

(Patent Document 1) U.S. Pat. No. 6,473,235

(Patent Document 2) U.S. Pat. No. 7,499,038

### SUMMARY OF THE INVENTION

The present invention has been made in an effort to provide a touch panel in which an electrode pattern is opened (or disconnected) along a shape of an electrode and a light blocking portion is formed to extend from an end portion of the opened pattern and have a predetermined angle with respect to the end portion to prevent an introduction of light even though an introduction path of light and a direction in which opened portions are arranged are consistent, thus preventing the opened portion from being visible.

According to an embodiment of the present invention, there is provided a touch panel including: a transparent substrate and an electrode pattern disposed in a mesh form on the transparent substrate to form an electrode, wherein the electrode pattern is opened along a shape of an electrode and a light blocking portion is disposed to extend from an end portion of the opened electrode pattern and have a predetermined angle with respect to the end portion.

The light blocking portion may include a bent portion formed to be bent from the opened end portion of the electrode pattern.

The bent portion may be bent from the opened end portion of the electrode pattern at a predetermined angle and extend to have a linear shape in the bent direction.

The bent portion may be bent from the opened end portion of the electrode pattern at a predetermined angle and extend to have a curved shape in the bent direction.

The bent portion may be formed in each opened end portion of the electrode pattern and bent in a direction different from each end portion of the electrode pattern.

The bent portion may be bent from each opened end portion of the electrode pattern at a predetermined angle within a range of 90° in the bent direction.

The light blocking portion may be formed to have an irregular shape or in an irregular direction in the opened end portion of the electrode pattern.

The transparent substrate may be made of polyethylene terephthalate (PET), polycarbonate (PC), polymethyl methacrylate (PMMA), polyethylene naphthalate (PEN), polyethersulfone (PES), a cyclic olefin copolymer (COC), triacetylcellulose (TAC) film, a polyvinyl alcohol (PVA) film, a polyimide (PI) film, polystyrene (PS), biaxially oriented PS (BOPS) containing K resin, glass, and tempered glass.

One surface of the transparent substrate may be subjected to a high frequency treatment or a primer treatment.

The electrode pattern or the light blocking portion may be made of any one of poly-3,4-ethylenedioxythiopene/polystyrenesulfonate (PEDOT/PSS), polyaniline, polyacetylene, and polyphenylenevinylene.

The electrode pattern or the light blocking portion may be made of a paste including any one of palladium, platinum, and silver.

The electrode pattern or the light blocking portion may be formed as a silver halide emulsion layer.

The electrode pattern or the light blocking portion may be made of silver (Ag), copper (Cu), aluminum (Al), or a combination thereof.

### BRIEF DESCRIPTION OF THE DRAWINGS

The above and other objects, features, and advantages of the present invention will be more clearly understood from the following detailed description taken in conjunction with the accompanying drawings, in which:

FIGS. 1 and 2 are a conceptual view and a partially enlarged view illustrating an electrode pattern according to an embodiment of the present invention; and

FIGS. 3 through 7 are conceptual views illustrating a device for forming an electrode pattern according to an embodiment of the present invention by using a planar plate.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like, are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

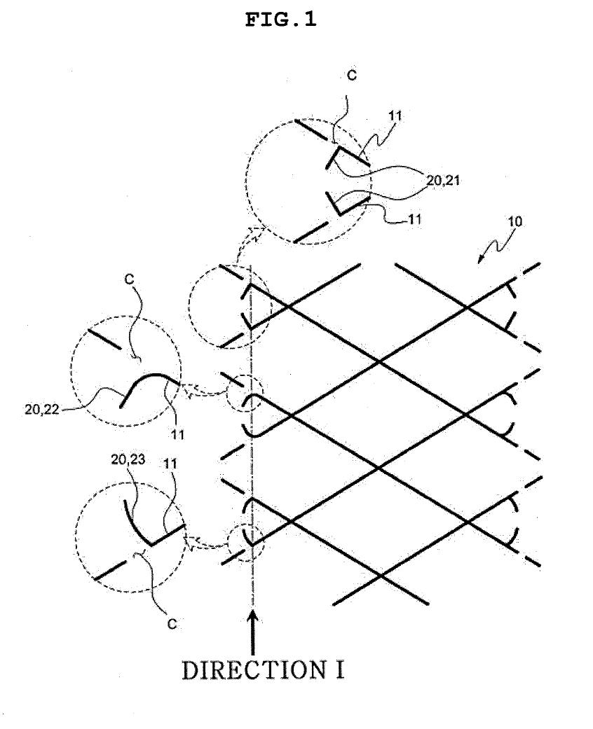

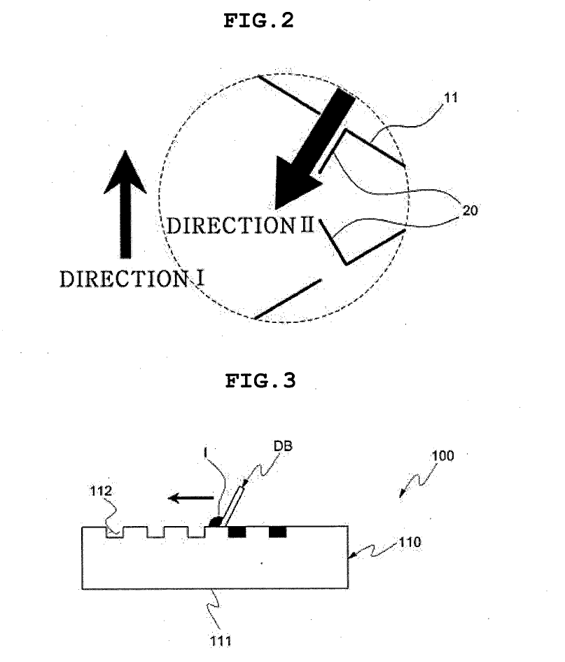

FIGS. 1 and 2 are a conceptual view and a partially enlarged view illustrating an electrode pattern according to an embodiment of the present invention, and FIGS. 3 through 7 are conceptual views illustrating a device for forming an electrode pattern according to an embodiment of the present invention by using a planar plate.

A touch panel according to an embodiment of the present invention includes a transparent substrate (not shown) and an electrode pattern 10 disposed in a mesh form on the transparent substrate to form an electrode. The electrode pattern 10 is opened along a shape of the electrode, and includes a light blocking portion 20 extending from an end portion of the opened electrode pattern 10 and disposed to have a predetermined angle with respect to the end portion 11.

Namely, as illustrated in FIG. 1, when an opened portion C is formed in a vertical direction on the drawing in the electrode pattern 10, the light blocking portion 20 is formed in the end portion of the opened electrode pattern 10, and in this case, the light blocking portion 20 disposed to have a predetermined angle with respect to the end portion 11 such that it is not consistent with the opening portion (i.e., the direction I).

Referring to the related art as described above, the opened end portion of the electrode pattern is identical to the direction in which opened portions are arranged, so if the direction in which the opened portions are arranged is identical to a path of light, light may be introduced between the opened portions, making the opened portion visible.

Thus, as illustrated in FIG. 2, the present invention solves the problem such that the direction (the direction I) in which the opened portions are arranged and a direction (a direction II) in which light is introduced are different by the presence of the light blocking portion 20, preventing light from being introduced to the opened portion, and thus, such a phenomenon that an opened portion is visible as in the related art does not occur.

The light blocking portion 20 is not formed to parallel so as to be inconsistent with the direction (direction I) of the opened portion.

Here, as illustrated in FIG. 1, the light blocking portion 20 may have a shape of a straight line or a curved line bent from the opened end portion 11 of the electrode pattern 10.

Namely, as described above, a linear light blocking portion 21 or curved light blocking portions 22 and 23 may be provided.

For example, like the light blocking portion denoted by reference numeral 22, it may have a linear shape and rounded by a predetermined angle from the end portion 11 of the electrode pattern 10 or, like the light blocking portion denoted by reference numeral 23, it may have an arc-shaped curved line from the end portion 11.

In other words, as mentioned above, the light blocking portion 20 according to an embodiment of the present invention is formed in the end portion 11 of the electrode pattern 10 to serve to block an introduction of light, but the present invention is not limited thereto and although the shape of the light blocking portion is changed, it may be within the scope of the present invention as long as it achieves the above mentioned object.

Meanwhile, as illustrated in FIG. 1, the light blocking portion 20 may be formed to have an irregular shape or in an irregular direction in the opened end portion 11 of the electrode pattern 10 to stably block an introduction of light.

Namely, in an upper portion of the electrode pattern 10 on the drawing, linear light blocking portions 21 may be formed in a direction in which they are symmetrical, rather than in the same direction.

Also, unlike the linear light blocking portions 21, rounded light blocking portions 22 may be formed in a portion under the linear light blocking portions 21 on the drawing, and in this case, the rounded light blocking portions 22 may be formed in a direction in which they are symmetrical.

This may be applicable in the same manner in case of forming the light blocking portions 23 having an arc shape formed under the rounded light blocking portions 22.

In other words, the light blocking portions 20 according to an embodiment of the present invention may be formed irregularly to have various shapes as mentioned above, and may also be disposed in different directions.

Meanwhile, the transparent substrate may be made of polyethylene terephthalate (PET), polycarbonate (PC), polymethyl methacrylate (PMMA), polyethylene naphthalate (PEN), polyethersulfone (PES), a cyclic olefin copolymer (COC), triacetylcellulose (TAC) film, a polyvinyl alcohol (PVA) film, a polyimide (PI) film, polystyrene (PS), biaxially oriented PS (BOPS) containing K resin, glass, tempered glass, or the like. Also, in order to enhance bonding strength of the transparent substrate, one surface of the transparent substrate may be subjected to a high frequency treatment (or induction hardening) or a primer treatment.

The electrode pattern 10 or the light blocking portion 20 may be made of copper (Cu), aluminum (Al), gold (Au), silver (Ag), titanium (Ti), palladium (Pd), chromium (Cr), or a combination thereof. Here, the electrode pattern 10 may be formed through a plating process or a deposition process using a sputter. Also, the electrode pattern 10 or the light blocking portion 20 may be formed with a paste including any one of palladium, platinum, and silver through a general printing process. Here, the silver paste, having high conductivity and reliability, is most commonly used as a conductive paste, but in order to solve a problem such as ion migration, or the like, palladium or platinum may be included.

The light blocking portion 20, extending on the electrode pattern 10, may be integrally formed in the manufacturing process and may have a predetermined pattern or an irregular pattern in order to lower visibility based on light transmittance according to an embodiment of the present invention.

Also, the electrode pattern 10 or the light blocking portion 20 may be made of a conductive polymer. Specifically, the electrode pattern 10 or the light blocking portion 20 may be made of poly-3,4-ethylenedioxythiopene/polystyrenesulfonate (PEDOT/PSS), polyaniline, polyacetylene, polyphenylenevinylene, or the like. Meanwhile, besides the foregoing metal, the electrode pattern 10 or the light blocking portion 20 may be made of a metal oxide such as metal silver, indium tin oxide (ITO), or the like, formed by exposing and developing a silver halide emulsion layer.

Also, the electrode pattern 10 may be made of a hybrid silver paste including silver powder having a particle diameter ranging from 3 um to 5 um and silver nano-particles having a diameter ranging from 2 nm to 8 nm. Here, the hybrid silver paste including the silver powder and the silver nano-particles may be formed by dispersing the silver powder and the silver nano-particles in an organic solvent and cured at a temperature (ranging from 180° C. to 220° C.) by using a binder as a thermosetting resin under a viscosity condition ranging from 2 Pa·S to 100 Pa·S.

Also, the electrode pattern 10 or the light blocking portion 20 may be made of a carbon paste including carbon black or acetylene black. Here, the foregoing carbon paste has chemically or physically stable characteristics and is low in price.

Hereinafter, an apparatus 100 for forming the electrode pattern 10 and the light blocking portion 20 will be described with reference to an embodiment illustrated in FIGS. 3 through 7.

The apparatus 100 may include a planar plate 110, an ink applying unit DB, a transmission unit 120, and a base 130 with a transparent substrate S formed thereon.

The planar plate 110 includes a plurality of recess portions 112 formed on a body 111 of the planar plate 110 having a plate body shape. Here, the recess portions 112 have the same shape as that of the electrode pattern 10 and the light blocking portion 20 as described above. In other words, the recess portion 112 has a shape of the electrode pattern 10 (See FIG. 1, which is the same, hereinafter) having a mesh form and also includes an opened portion C (See FIG. 1, which is the same, hereinafter). In this case, the recess portion 112 also includes the light blocking portion 20 (See FIG. 1, which is the same, hereinafter) formed in the end portion 11 of the electrode pattern 10.

When the recess portions 112 are filled with conductive ink, it may have the same shape as the electrode pattern 10 including the opened portion C and the light blocking portion 20.

Meanwhile, in FIG. 3, it is illustrated that the recess portions 112 are arranged in a straight line, but it is merely for the description purpose and an actual configuration of the recess portions 112 may be the same as the electrode pattern 10 and the light blocking portion 20 as described above, which also is applied in the same manner to a description below and a repeated description thereof will be omitted.

Meanwhile, in order to fill the recess portions 112 of the planar plate 110 with conductive ink, the ink applying unit DB may be provided. The ink applying unit DB serves to fill the recess portions 112 with the conductive ink I by jetting, transferring, or the like, the conductive ink I. In FIG. 3, it is illustrated that the ink applying unit DB has a thin plate shape and tightly attached to the planar plate 110, but the present invention is not limited thereto and any other types of units (e.g., an inkjet for jetting conductive ink, or the like) may be within the scope of the present invention as long as it can fill the recess portions 112 with the conductive ink I as described above.

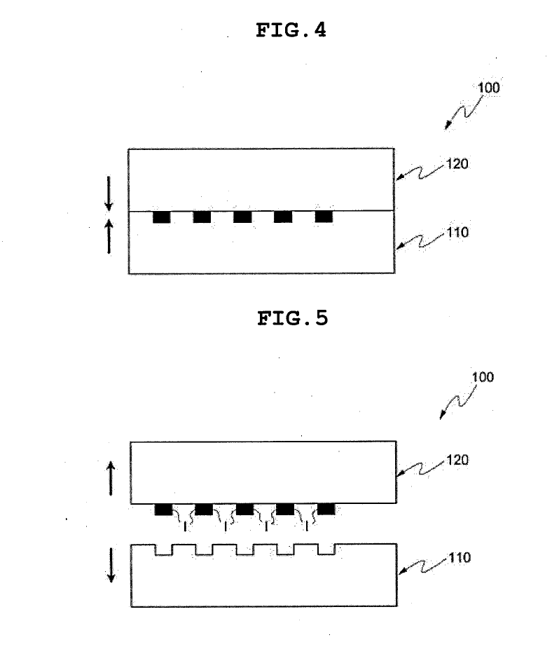

Meanwhile, as illustrated in FIGS. 4 and 5, the transmission unit 120 is in contact with the planar plate 110 to allow the conductive ink I filled in the recess portions 112 to be transferred from the planar plate 110, to the transmission unit 120. Here, the planar plate 110 and the transmission unit 120 may be made of polydimethylsiloxane (PDMS). PDMS is a silicon-based material as widely known, and by differentiating a composition thereof, adhesion for the conductive ink Ito be adhered can be adjusted. Namely, as illustrated in FIG. 5, when adhesion of the transmission unit 120 is stronger than that of the planar plate 110, the conductive ink I filled in the recess portions 112 of the planar plate 110 may be transferred from the recess portions 112 to the transmission unit 120.

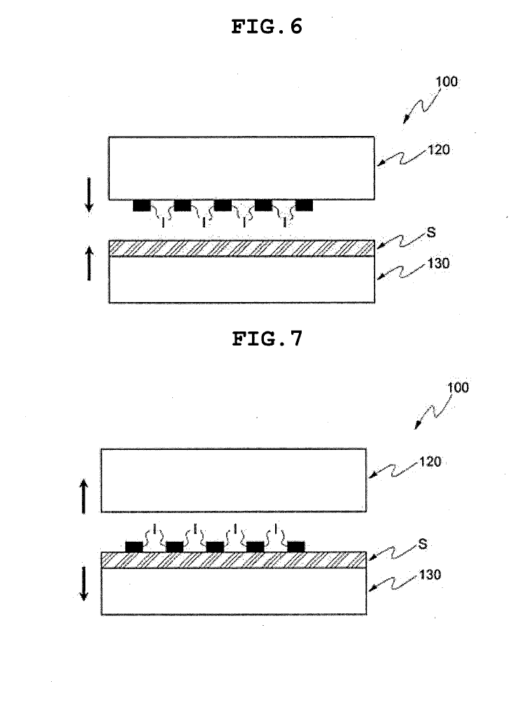

Meanwhile, in the case of the base 130, as illustrated in FIG. 6, the transparent substrate S may be disposed on an upper portion thereof. Here, when the transmission unit 120 is brought into contact with the transparent substrate S and subsequently separated, the conductive ink I may be patterned on the transparent substrate S as illustrated in FIG. 7. Meanwhile, even in the case of FIG. 6, adhesion with the conductive ink may be adjusted to allow the conductive ink I to be transferred from the transmission unit 120 to the transparent substrate S.

Here, the base 130 may be made of any one of polyethylene terephthalate (PET), polyethylene naphthalate (PEN), polycarbonate (PC), polyimide, and polyarylate.

Transparent glass is commonly used due to its excellent chemical stability and excellent strength.

PET, produced by condensation-polymerizing ethylene and terephthalate, has excellent chemical durability and excellent tensile strength as a thermosetting resin.

PEN, in which n number of monoliths comprised of two benzene rings, two ester groups, and two methyl groups are connected, has also excellent durability and chemical stability.

PC has high heat resistance and excellent low temperature characteristics (135° C. to −100° C.), is stable with light, and is scarcely oxidized when processed.

Polyamide, a generic term of a polymer connected by an amide bond (—CONH—), has excellent heat resistance, mechanical properties, electric characteristics, and chemical resistance.

Polyarylate, a mixture acid of terephthalic acid and isophthalic acid, is a polycondensation-based polymer generated from bisphenol A. Polyarylate has excellent transparency and heat resistance.

Hereinafter, a method of forming an electrode pattern on the transparent substrate S will be described with reference to FIGS. 3 through 7.

First, as illustrated in FIG. 3, the recess portions 112 of the planar plate 110 are filled with the conductive ink I by using the ink applying unit DB. Next, as illustrated in FIG. 4, the transmission unit 112 is brought into contact with the planar plate 110, and subsequently separated as illustrated in FIG. 5. Accordingly, the conductive ink I is transferred from the recess portions 112 to the transmission unit 120. Here, the transferred conductive ink I has the same shape as those of the electrode pattern 10 and the light blocking portion 20.

Thereafter, as illustrated in FIGS. 6 and 7, the transmission unit 120 is brought into contact with the base 130 and subsequently separated to allow the conductive ink I to be attached to the transparent substrate S. As described above, the conductive ink I on the transparent substrate S is subjected to the processes such as curing, drying, and the like, to form the electrode pattern.

According to the preferred embodiments of the present invention, since the light blocking portion is formed in the opened end portion of the electrode pattern, although a light introduction path and an opened portion arrangement direction are consistent, an introduction of light is prevented, thus preventing the opened portion from being visible.

Although the embodiments of the present invention have been disclosed for illustrative purposes, it will be appreciated that the present invention is not limited thereto, and those skilled in the art will appreciate that various modifications, additions, and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A touch panel comprising a transparent substrate and an electrode pattern disposed in a mesh form on the transparent substrate to form an electrode,
wherein the electrode pattern is opened along an electrode shape and a light blocking portion is disposed to extend from an end portion of the opened electrode pattern and have a predetermined angle with respect to the end portion.

2. The touch panel as set forth in claim 1, wherein the light blocking portion includes a bent portion formed to bent from the opened end portion of the electrode pattern.

3. The touch panel as set forth in claim 2, wherein the bent portion is bent from the opened end portion of the electrode pattern at a predetermined angle and extend to have a linear shape in the bent direction.

4. The touch panel as set forth in claim 2, wherein the bent portion is bent from the opened end portion of the electrode pattern at a predetermined angle and extend to have a curved shape in the bent direction.

5. The touch panel as set forth in claim 2, wherein the bent portion is formed in each opened end portion of the electrode pattern and bent in a direction different from each end portion of the electrode pattern.

6. The touch panel as set forth in claim 2, wherein the bent portion is bent from each opened end portion of the electrode pattern at a predetermined angle within a range of 90° in the bent direction.

7. The touch panel as set forth in claim 1, wherein the light blocking portion is formed to have an irregular shape or in an irregular direction in the opened end portion of the electrode pattern.

8. The touch panel as set forth in claim 1, wherein the transparent substrate is made of polyethylene terephthalate (PET), polycarbonate (PC), polymethyl methacrylate (PMMA), polyethylene naphthalate (PEN), polyethersulfone (PES), a cyclic olefin copolymer (COC), triacetylcellulose (TAC) film, a polyvinyl alcohol (PVA) film, a polyimide (PI) film, polystyrene (PS), biaxially oriented PS (BOPS) containing K resin, glass, and tempered glass.

9. The touch panel as set forth in claim 8, wherein one surface of the transparent substrate is subjected to a high frequency treatment or a primer treatment.

10. The touch panel as set forth in claim 1, wherein the electrode pattern or the light blocking portion is made of any one of poly-3,4-ethylenedioxythiopene/polystyrenesulfonate (PEDOT/PSS), polyaniline, polyacetylene, and polyphenylenevinylene.

11. The touch panel as set forth in claim 1, wherein the electrode pattern or the light blocking portion is made of a paste including any one of palladium, platinum, and silver.

12. The touch panel as set forth in claim 1, wherein the electrode pattern or the light blocking portion is formed as a silver halide emulsion layer.

13. The touch panel as set forth in claim 1, wherein the electrode pattern or the light blocking portion is made of silver (Ag), copper (Cu), aluminum (Al), or a combination thereof.
